(19) United States
(12) Patent Application Publication
(10) Pub. No.: US 2012/0078909 A1
(43) Pub. Date: Mar. 29, 2012

(54) INFORMATION SELECT APPARATUS AND INFORMATION SELECT METHOD

(75) Inventors: Kenji ODAKA, Yokohama-shi (JP); Satoshi Ozaki, Kawasaki-shi (JP); Eiji Tokita, Kawasaki-shi (JP)

(73) Assignee: KABUSHIKI KAISHA TOSHIBA, Tokyo (JP)

(21) Appl. No.: 13/306,847

(22) Filed: Nov. 29, 2011

Related U.S. Application Data
(63) Continuation of application No. PCT/JP2009/004807, filed on Sep. 24, 2009.

(51) Int. Cl. G06F 17/30

(52) U.S. Cl. 707/737; 707/E17.001

(57) ABSTRACT

According to one embodiment, an information select apparatus includes a storage, an acquisition module, and a selector. The storage is configured to store a script in which at least first information indicative of a search condition of articles, second information indicative of a select condition of articles, and third information indicative of an output order of articles are described, in order to select data which is to be provided to a user. The acquisition module is configured to acquire a data group from a network according to the first information of the script. The selector is configured to select data items from the data group according to the second information of the script, and to orderly arrange the selected data items according to the third information.

### CROSS-REFERENCE TO RELATED APPLICATIONS

This application is a Continuation Application of PCT Application No. PCT/JP2009/004807, filed Sep. 24, 2009, the entire contents of which are incorporated herein by reference.

### FIELD

Embodiments described herein relate generally to an information select apparatus and an information select method.

### BACKGROUND

Conventionally, such techniques have been invented that a playlist is automatically generated in a PC (personal computer) from many music libraries in consideration of a user's preference (Jpn. Pat. Appln. KOKAI Publication No. 2008-217254). Meanwhile, in the Web, such functions, as a track-back function of blogs or a social bookmark, which provide link information which is positively created by viewers of Web sites, have been gaining in popularity. These functions, compared to a routinely search or ranking, can provide information of high relevance in accordance with the user's interest.

However, since the above-described functions presuppose that the user actively select information, a providing side provides information, without paying special attention to whether the information is needed by the user or not. Thus, there is a possibility that unnecessary information is provided to the user.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing the structure of an information select apparatus according to a first embodiment of the present invention.

FIG. 2 is a view showing a structure of the description of a script in the first embodiment.

FIG. 3 shows an example of the description of the script in the first embodiment.

FIG. 4 is a flow chart illustrating the operation of the first embodiment.

FIG. 5 is a flow chart illustrating the operation of the first embodiment.

FIG. 6 shows an example of a search result by a query to an information aggregation site in the first embodiment.

FIG. 7 shows an example of an information select result in the first embodiment.

FIG. 8 shows an example of an information select result in the first embodiment.

FIG. 9 is a block diagram showing the structure of an information select apparatus according to a second embodiment of the present invention.

FIG. 10 is a flow chart illustrating the operation of the information select apparatus according to the second embodiment.

FIG. 11 is a flow chart illustrating a sorting operation of contents in the second embodiment.

FIG. 12 is a view for explaining a sorting operation of contents having a certain characteristic in the second embodiment.

FIG. 13 is a view for explaining a sorting operation of contents with another characteristic in the second embodiment.

FIG. 14 is a view for explaining a sorting operation of contents with another characteristic in the second embodiment.

FIG. 15 is a view for explaining a sorting operation of contents with another characteristic in the second embodiment.

FIG. 16 is a view for explaining a sorting operation of contents with another characteristic in the second embodiment.

### DETAILED DESCRIPTION

Various embodiments will be described hereinafter with reference to the accompanying drawings.

In general, according to one embodiment, an information select apparatus includes a storage, an acquisition module, and a selector. The storage is configured to store a script in which at least first information indicative of a search condition of articles, second information indicative of a select condition of articles, and third information indicative of an output order of articles are described, in order to select data which is to be provided to a user. The acquisition module is configured to acquire a data group from a network according to the first information of the script. The selector is configured to select data items from the data group according to the second information of the script, and to orderly arrange the selected data items according to the third information.

### First Embodiment

In a first embodiment, a description is given of an apparatus which automatically displays news or articles of blogs on the Web, and enabling browsing without a user's operation.

A simple example of such an apparatus is a TV. In news programs of TV broadcast, the contents of information or the method of providing information is different in accordance with the time/day of broadcast. For example, the following program structures may be used.

<Contents of Morning News Program>
In the morning, a flash report of news occurring in the midnight of yesterday, or information during the daytime of yesterday about entertainments, etc., which is rarely provided in nighttime news, is treated.
Since there is no enough time before going to work, the latest news is treated.

<Contents of daytime news program>
Information, which was not treated in the morning news, is treated.
Information, which has occurred since the morning news, is treated.
Information on living is treated.

<Contents of Evening News Program>
Information, which occurred during the daytime, is mainly treated, and a special event, if any, is treated in detail.

<Contents of Nighttime News Program>
Information on economy is mainly treated.
Information on sports of today is mainly treated.

<Contents of News Program Before Holiday>
In addition to nighttime news, information on leisure or information on an event, which is to be held on a holiday, are treated.
<Contents of News Program of Holiday>
Of events occurring in weekdays, a main topic is treated with much time.

In this manner, as regards the news of the TV program, the contents to be provided and the order of provision are changed in accordance with the situation of viewing. Thereby, the information, which is needed by the viewer, who views the TV program, in accordance with the time zone and the day of the week, is provided.

In the present embodiment, a description is given of an apparatus which can perform, on the Web, the same as with the above-described news of the TV program. Specifically, an apparatus, which automatically displays news or articles of blogs on the Web without the user's operation, is made to be able to display different contents in accordance with the time of use by the user or the preference of the user.

The information of the Web is not delivered in accordance with the situation of use by the user. Thus, in the present embodiment, in order to change the information which is displayed in accordance with the time/condition, as in the TV program, articles which are output in accordance with the condition of use by the user are selected from the news or articles of blogs on the Web, which are collected by an information aggregation site on the Web which operates by the same algorism/scheme around the clock. As a method for realizing this, use is made of an article search query for acquiring a population, which becomes article candidates to be output, from information aggregation sites on the Web such as social bookmarks, and a script having an output condition for selecting information from the acquired information. Thereby, Web delivery according to the condition of use and the preference of the user is realized.

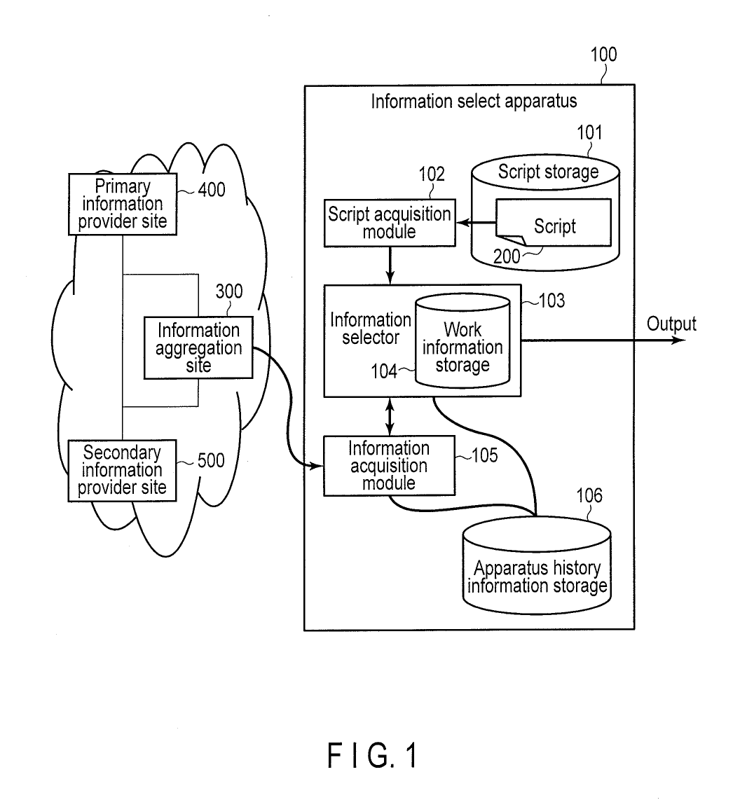

FIG. 1 is a block diagram showing the structure of an information select apparatus according to the embodiment.

An information select apparatus 100 comprises a script storage 101, a script acquisition module 102, an information selector 103, a work information storage 104, an information acquisition module 105, and an apparatus history information storage 106.

The script storage 101 stores a script 200. The script 200 is created by such methods as manual creation by the user, or automatic generation by a routine algorithm, in the information select apparatus 100 or on the outside of the apparatus. The details of the script 200 will be described later.

In accordance with an instruction of the information selector 103, the information acquisition module 105 acquires information necessary for the processing of the information selector 103, from the apparatus history information storage 106 and an information aggregation site 300 on the Internet.

The information aggregation site 300 is, for instance, a social bookmark such as “Hatena bookmark”. The information aggregation site 300 collects, as primary information, news and articles of blogs which are made public on the Web, from a plurality of primary information provider sites 400. In addition, the information aggregation site 300 has databases in which reaction information, such as links and comments on secondary information of a relevant secondary information provider site 500, is aggregated in connection with the respective articles. Based on these databases, the information aggregation site 300 creates a list of articles in the order beginning with a new one or in accordance with a condition such as the number of reaction information pieces, and provides the list.

The apparatus history information storage 106 stores information relating to apparatus use conditions such as the number of times of use, the time of use and time points of use of the information select apparatus 100, a history or cache of information of the information aggregation site 300 which has been acquired by the information acquisition module 105, and a history or cache of an output result of the information selector 103.

The script acquisition module 102 reads in the script 200 from the script storage 101. In addition, the script acquisition module 102 delivers the script 200 to the information selector 103.

The information selector 103 selects, according to the script 200, the information of the information aggregation site 300 on the Web, which has been acquired by the information acquisition module 105. Then, the information selector 103 stores the selected information in the work information storage 104. Further, the information selector 103 outputs the data, which is stored in the work information storage 104, to a display device (not shown) or the like in the order according to the script 200.

The work information storage 104 stores information which is selected by the information selector 103. The work information storage 104 may be included in the information selector 103, as shown in FIG. 1, or may be connected to the outside of the information selector 103.

Next, a description is given of the script 200 which is processed in the information select apparatus 100.

The script 200 includes at least first information indicative of a search condition of articles, second information indicative of a select condition of articles, and third information indicative of the order of output of articles.

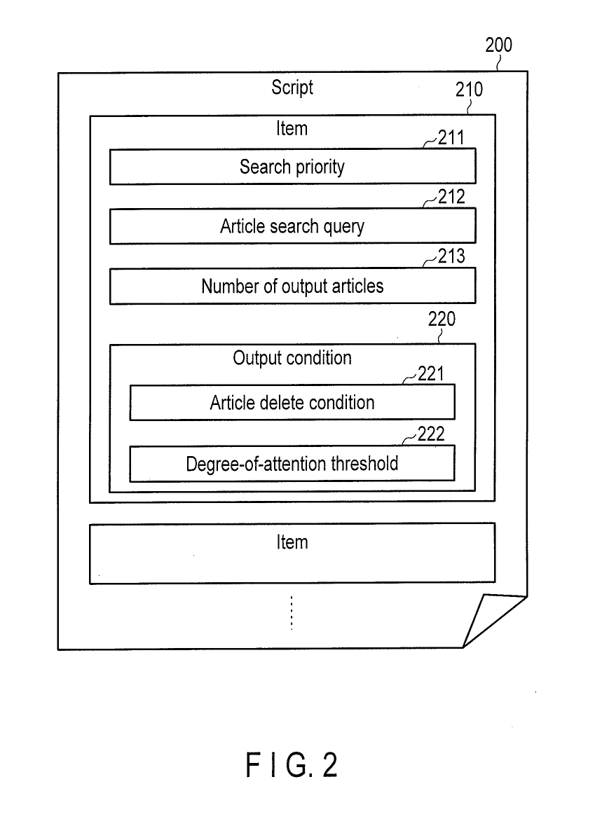

FIG. 2 is a view showing a description structure of the script 200 in the embodiment. The script 200 includes an item 210. The script 200 may include a plurality of items 210, and the order of arrangement of items 210 in the script corresponds to the order of output (corresponding to the above-described third information) of the information select apparatus 100.

The item 210 has an article search condition (corresponding to the above-described first information) for the information aggregation site 300, and a select condition (corresponding to the above-described second information) which is used when articles are selected from the search result. Specifically, the item 210 has a search priority 211 and an article search query 212 as parameters of the article search condition (first information). In addition, the item 210 has an output article number 213 and an output condition 220 as parameters of the article select condition (second information). By these parameters, flexible output information, like a TV news program, can be constructed. The parameters will be explained below.

The search priority 211 determines the order of queries to the information aggregation site 300 when a plurality of items 210 are present in one script 200. Specifically, the search priority 211 determines the order of search of the items 210 in the script 200. The search priority 211 is indicative of the degree of importance of information itself, and is different from the order of arrangement of items 210. However, the value of the search priority 211 may agree with the order of output of items 210, as in such a case that at the time of information output, the information selector 103 executes an output process in the order of the search priority 211, regardless of the order of output.

The article search query 212 specifies a condition in order to search the information aggregation site 300 for articles that meet a predetermined condition. These articles become a population when output information is selected in the information selector 103. The content of the article search query may be, for instance, a classification (genre) specified by the information aggregation site 300, or a search keyword. However, when the information aggregation site 300 has a function of narrowing down a search result, such as a filtering function of news sites or blog sites, it is assumed that an item for such a narrowing-down function is also included in the article search query 212. In addition, the articles, which have been collected from the information aggregation site 300 according to the article search query 212, are listed as a search result list. The order of arrangement of articles in the search result list may be set by sorting original articles in an order beginning with the latest posted one or the earliest posted one.

The output article number 213 specifies the maximum number of articles, which are selected by the information selector 103 and are output, from the search result list that is acquired by the article search query 212. The information selector 103 selects articles from the search result list that is acquired by the article search query 212, and loops and repeats the process until the number of selected articles meets the output article number.

The output condition 220 specifies a condition for narrowing down the number of articles in the search result list, which is created by the article search query 212, to the output article number 213. The output condition 220 includes an article delete condition 221 and a degree-of-attention threshold 222.

The article delete condition 221 specifies a condition for filtering information by using the search result by the article search query 212 or cache information of previously accessed articles, which is stored in the apparatus history information storage 106. Examples of the article delete condition 221 may include the period of posting of articles, a black list/white list of keywords included in URLs or the title/summary/text of improper sources of provision, a history of the information of the information aggregation site 300 acquired by the information acquisition module 105, which is included in the apparatus history information storage 106, and a flag as to whether or not to delete an article that is present in the history of the information of the information aggregation site 300. However, in the case where the information aggregation site 300 provides, in addition to the above, the information which is usable for filtering, it is possible to add the delete condition, which uses this information, to the article delete condition 221.

The degree-of-attention threshold 222 sets the threshold of the degree of attention, which is required for output articles. For example, the degree-of-attention threshold 222 is the number of users who pay attention to the article, the number of articles mentioned as relevant articles on the information aggregation site 300, the number of other articles described in association with the article, and the number of direct comments or tack-backs on the article. However, in the case where the information aggregation site 300 provides, in addition to the above, information relating to the degree of attention to information, a condition using this information may be added to the degree-of-attention threshold 222. A plurality of conditions can be described as the degree-of-attention threshold 222. Besides, a flexible condition may be described by coupling a plurality of conditions by an operator such as AND/OR.

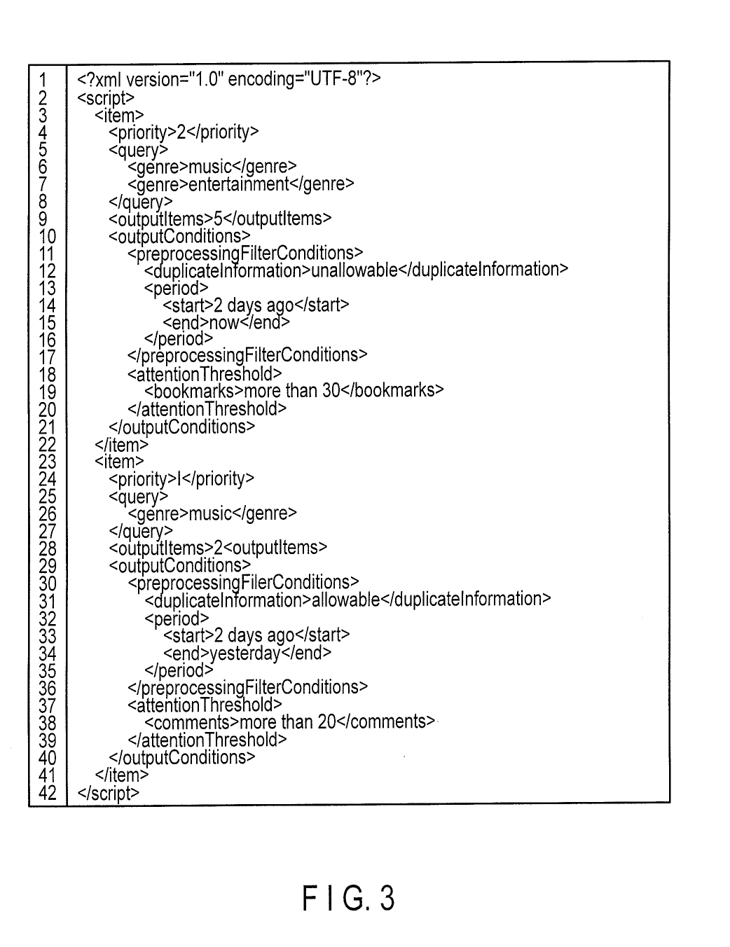

Next, referring to FIG. 3 to FIG. 8, the operation of the information select apparatus 100 of the embodiment is described.

FIG. 3 shows an example of the description by XML of the script in the embodiment. In the example of the description of the script in FIG. 3, lines 3 to 22 indicate a first item, and lines 23-41 indicate a second item.

In the script, the search priority 211 is expressed by a tag <priority>. This is described in line 4 in the first item and in line 24 in the second item. In this example of the description, the priority is higher as the value described in the text element of <priority> is smaller.

The article search query 212 is expressed by a tag <query>. This is described in lines 5-8 in the first item and in lines 25-27 in the second item. A sub-element of <query> is the content of the search query. In the first item, two contents, i.e. music and entertainment, are designated as the genre <genre>. In the second item, music is designated as the genre <genre>.

The output article number 213 is expressed by a tag <output Items>. This is described in line 9 in the first item and in line 28 in the second item.

The output condition 220 is expressed by a tag <outputConditions>. The article delete condition 221 is indicated by a tag <preprocessingFilterConditions> which is a sub-element of <outputConditions>. The degree-of-attention threshold 222 is indicated by <attentionThreshold> which is a sub-element of <outputConditions>.

In the first item, lines 10-21 are the output condition 220. Of these lines, lines 11-17 are the article delete condition 221. Line 12, <duplicatelnformation>, sets a flag of “Whether or not to use an article which was used with a higher priority”, and in this example the flag is set to be “unallowable” (not permitted). Lines 13-16 are the description of the article posting period condition, and the period from two days ago (2 days ago) to the present (now) is allowed. Lines 18-20 indicate the degree-of-attention threshold 222, and line 19 is a concrete description of “the number of bookmarks is 30 or more”.

In the second item, lines 29-40 are the output condition 220. Of these lines, lines 30-36 are the article delete condition 221. Line 31, <duplicatelnformation>, sets a flag of “Whether or not to use an article which was used with a higher priority”, and in this example the flag is set to be “allowable” (permitted). Lines 32-35 are the description of the article posting period condition, and the period from two days ago (2 days ago) to yesterday (yesterday) is allowed. Lines 37-39 indicate the degree-of-attention threshold 222, and line 38 is a concrete description of “the number of comments is 20 or more”.

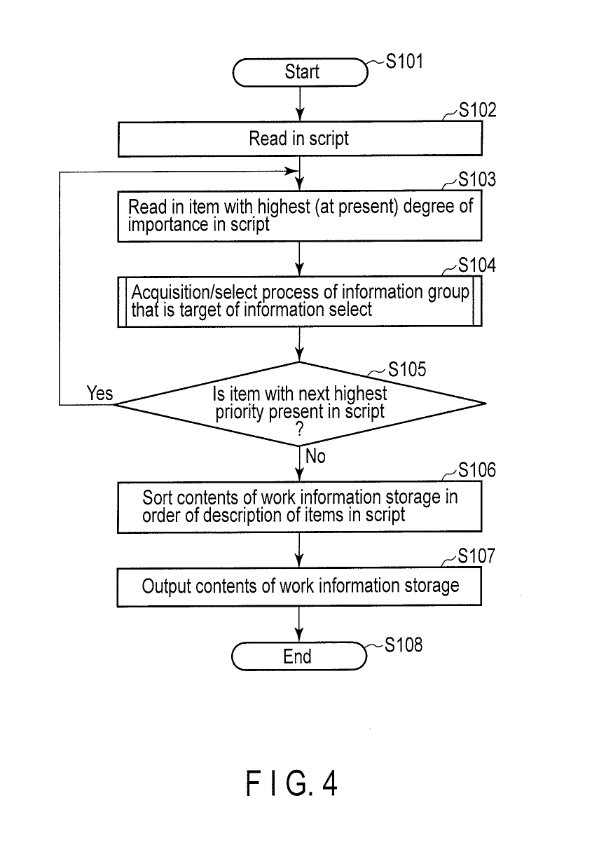

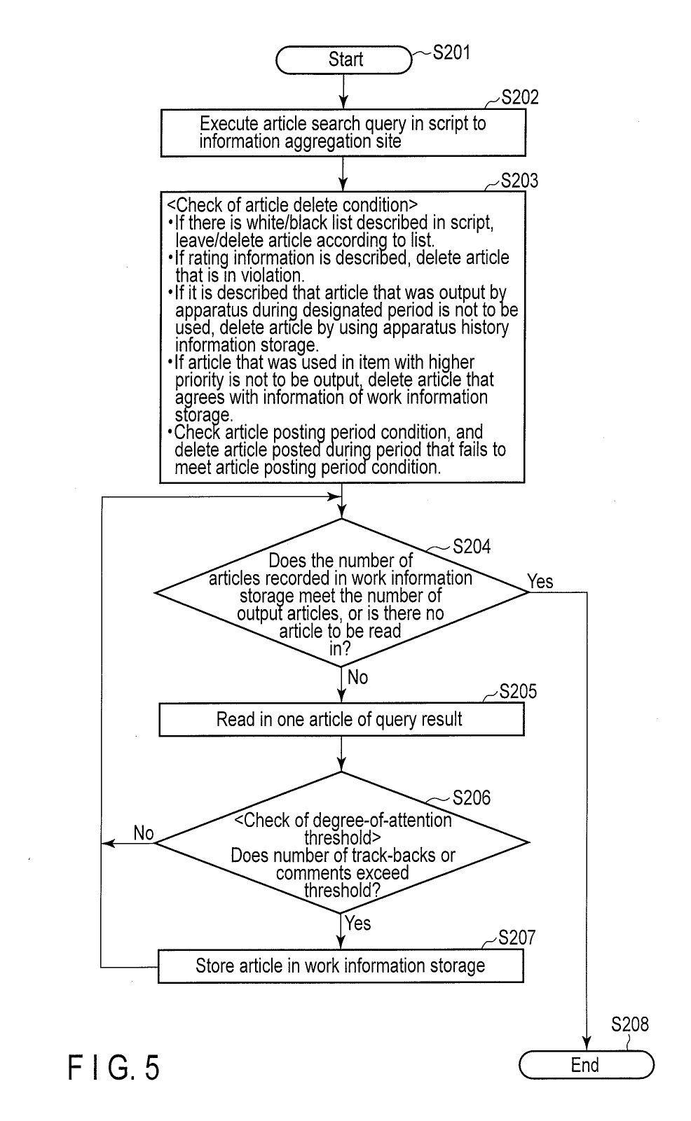

Next, a description is given of an operation in which the information select apparatus 100 processes the script 200 of FIG. 3. FIG. 4 shows a flow chart illustrating the operation of the information select apparatus 100 according to the present embodiment. FIG. 5 is a flow chart illustrating the details of step S104 in FIG. 4.

To begin with, in step S102 of FIG. 4, the script acquisition module 102 reads in the script 200 from the script storage 101, and the process starts. The script acquisition module 102 delivers the read-in script 200 to the information selector 103.

The information selector 103 reads in an item with a highest priority (at present) in the script 200 (step S103). In the example of the description of the script in FIG. 3, the priority is higher as the value of <priority> is smaller. Thus, the second item (lines 23-41) of priority “1” is read in.

The information selector 103 selects articles, which are output targets, with respect to the second item having the high priority, and stores the result in the work information storage 104 (step S104). FIG. 5 illustrates a detailed process in step S104, and the description thereof will be given later.

Next, the information selector 103 confirms whether an item with the second highest priority is present in the script 200 (step S105). When an item with the second highest priority is present in the script 200, the process of step S103 to step S105 is repeated on the item with the second highest priority, like the above-described second item. In the example of the script description of FIG. 3, the first item (lines 3-22) with the priority “2” is similarly processed.

When the process of the first item with the priority “2” has been completed, the information selector 103 stores the articles, which have been selected with respect to the two items, in the work information storage 104. In the example of the script description of FIG. 3, since there is no other item (NO in step S105), the process advances to the next step S106.

The information selector 103 sorts the contents of the work information storage 104 in the order of the item description in the script 200 (step S106). In the example of the script description of FIG. 3, the article select process is executed in the order of “second item and first item”. At the time of output, however, the processing result is output in the order of “first item and second item” according to the order of the description in the script. For this purpose, sorting is performed in step S106.

If the sorting is completed, the information selector 103 outputs the information of the work information storage 104 to the display device or the like (step S107). Thereby, the process of the information select apparatus 100 is completed.

Next, referring to FIG. 5, the detailed operation of the above-described step S104 is described. Using the example of the description of the script 200 in FIG. 3, the entire process of the second item with the priority “1” is first described, and then the process of the first item with the priority “2” is described. In the process of the first item with the priority “2”, use is made of the result of the process of the second item with the priority “1”, which is executed in precedence.

At the time of the start of the process in FIG. 5 (step S201), the information selector 103 is in the state in which the information selector 103 has read in the second item with the priority “1” of the script 200 from the work information storage 104.

The information selector 103 delivers the article search query 212 of the script 200 to the information acquisition module 105, and issues a request for search to the information aggregation site 300 on the Web (step S202).

The information acquisition module 105 acquires articles meeting the condition from the information aggregation site 300 on the Web, according to the article search query 212. These articles are listed in the search result list. The information acquisition module 105 delivers the search result list, as a content of response, to the information selector 103.

Upon receiving the search result list, the information selector 103 checks whether the articles in the search result list meet the article delete condition 221 (step S203).

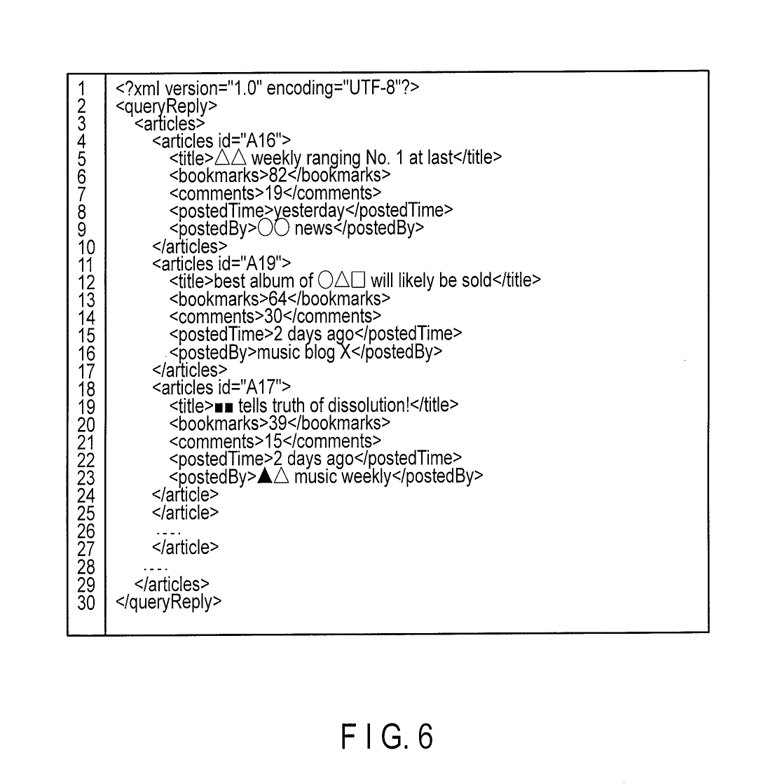

FIG. 6 shows an example in which the search result list is described by XML. In the Figure, “ . . . ” indicates an omission. In the example of the description of FIG. 6, <articles> is a tag indicative of an article group. One article is indicated by <article> which is a sub-element of <articles>. In the example of the description of FIG. 6, information relating to one article includes the following:
ID: This is given by the information aggregation site 300 in order to identify an article. The ID is indicated by an attribute “id” of “article”.
title tag: This represents the title of the article.
bookmarks tag: This represents the number of articles which are registered (bookmarked) as articles of interest by users of the information aggregation site 300.
comments tag: This indicates the number of comments on the article.
postedTime tag: This indicates the time at which the article was posted.
postedBy tag: This indicates a person or a medium which wrote the article.

Meanwhile, information other than the above may be used.

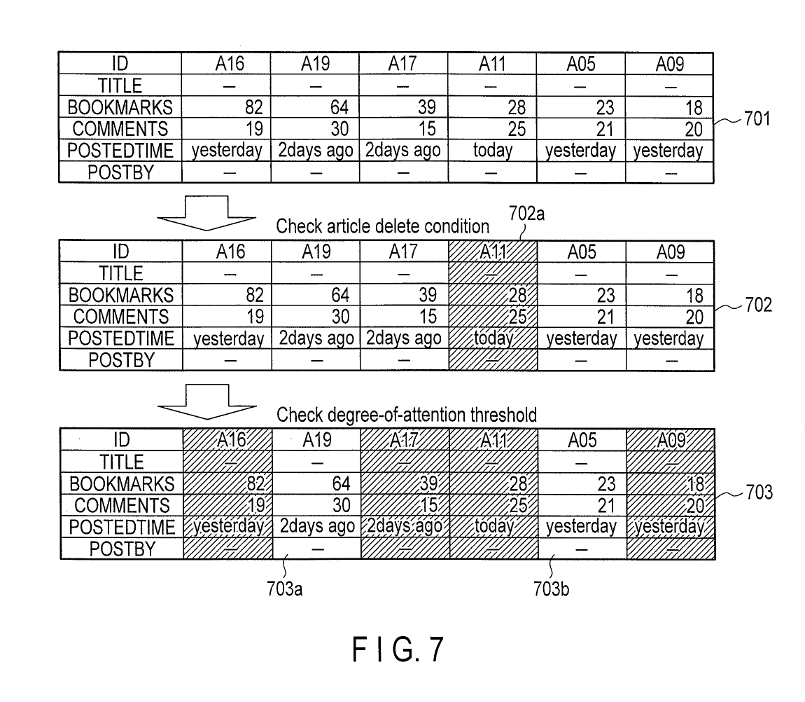

FIG. 7 shows a table in which search result lists relating to the second item with the priority “1” are summarized in brief. In this example, since neither the “title” tag nor “postedBy” tag is used, information on these is omitted (sign “−”) in FIG. 7. FIG. 7 shows a search result list 701 in the initial state, a search result list 702 after a check of the article delete condition 221, and a search result list 703 in the state in which all the process of FIG. 5 is completed. The article indicated by hatching indicates an article which was deleted in each process.

Using the example of the description of the script 200 of FIG. 3, a description is given of a process (step S203) of checking whether each of the articles in the search result list of FIG. 7 meets the article delete condition 221.

In the second item with the priority “1”, two article delete conditions 221 are set in the script. The first condition is <duplicateInformation>allowable</duplicateInformation> (see line 31 of FIG. 3). Specifically, the setting as to “Whether or not to use an article which was used with a higher priority” is “allowable”. Since there is no article with a higher priority in the same script, article delete is not executed under this condition. The second condition is described as <period>, <start>2 days ago</start>, <end>yesterday</end>, </period> in lines 32-35 in FIG. 3. Specifically, “in the description of the article posting period condition, only the period from two days ago (2 days ago) to yesterday (yesterday) is allowed.” In FIG. 7, since the posting of the article of ID=A11 is “today”, the article of ID=A11 is deleted (hatched part 702a of 702). If the check of the article delete conditions 221 described in the script 200 are completed, the process goes to step S204.

Next, the information selector 103 reads in the articles of the search result list 702 one by one (step S205) until the number of articles stored in the work information storage 104 meets the output article number 213 or until there remains no article that is to be read in from the search result list 702 (step S204). The process of steps S204 to S207 is repeatedly executed until there remains no article, and the process is finished if there remains no article.

The information selector 103 checks the degree-of-attention threshold 222 with respect to the read-in article if the article is present (step S206). If the degree of attention of the article exceeds the degree-of-attention threshold 222, this article is stored in the work information storage 104 (step S207). In the process of step S206, if the degree of attention of the article does not exceed the degree-of-attention threshold 222, the process returns to step S204.

In the search result list 702 of FIG. 7, if the process is executed from the left-side article, ID=A16 and ID=A17 fail to meet the degree-of-attention threshold, i.e. “the number of comments (COMMENTS) is 20 or more”, and thus these are not selected. On the other hand, since ID=A19 and ID=A05 meet the degree-of-attention threshold, i.e. “the number of comments (COMMENTS) is 20 or more”, these are stored in the work information storage 104.

At the time point when the process of ID=A05 is completed, the number of selected articles (two, i.e. ID=A19 and ID=A05) meets the output article number 213 (“2” in this example). Accordingly, the process of the second item with the priority “1” is completed. Although the number of comments on ID=A09 is 20 or more and meets the select condition, this article is not read in or selected since the entire process is completed.

As a result of the above process, articles 703a and 703b in white (not hatching) are selected as to-be-output articles, among the articles described in the search result list 703, and are stored in the work information storage 104.

Next, a description is given of the first item with the priority “2” (lines 3-22 of the script 200 shown in FIG. 3).

Like the second item with the priority “1” which was processed in precedence, the information selector 103 delivers the article search query 212 of the script 200 to the information acquisition module 105, and issues a request for search to the information aggregation site 300 on the Web (step S202).

The information acquisition module 105 acquires articles meeting the condition from the information aggregation site 300 on the Web, according to the article search query 212. These articles are listed in the search result list. The information acquisition module 105 delivers this search result list, as a content of response, to the information selector 103.

If the search result list by the article search query 212 is returned from the information acquisition module 105, the information selector 103 checks whether the articles in the search result list meet the article delete condition 221 (step S203).

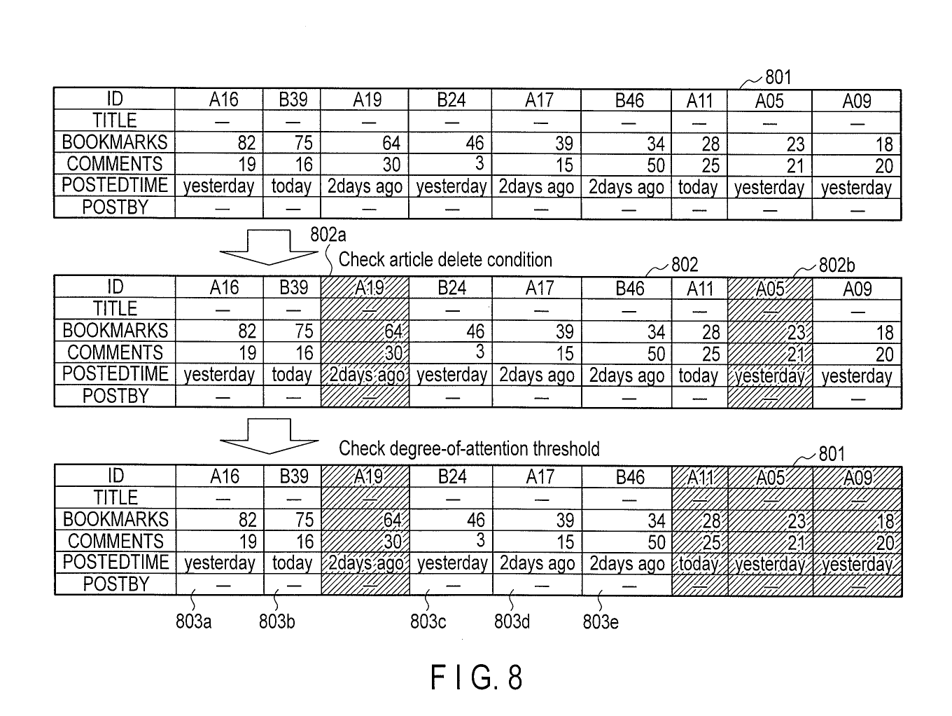

FIG. 8 shows a table in which search result lists relating to the first item with the priority “2” are summarized in brief. Like FIG. 7, FIG. 8 shows, from above, a search result list 801 in the initial state, a search result list 802 after a check of the article delete condition 221, and a search result list 803 in the state in which all the process of FIG. 5 is completed.

In the first item with the priority “2”, two genres of articles, i.e. “music” and “entertainment”, are designated in the search query. Of these, “music” is the same as in the second item with the priority “1”. Thus, in the search results shown in FIG. 8, ID=A16, ID=A19, ID=A17, ID=A11, ID=A05 and ID=A09 are the same articles with the same IDs as in FIG. 7.

Using the example of the description of the script of FIG. 3, a description is given of the process (step S203) of checking whether each of the articles in the search result list meets the article delete condition 221.

In the first item with the priority “2”, two article delete conditions 221 are set in the script 200. The first condition is <duplicateInformation>unallowable</duplicateInformation> (see line 12 of FIG. 3). Specifically, the setting as to “Whether or not to use an article which was used with a higher priority” is “unallowable”. Thus, the work information storage 104 is referred to, and the articles of ID=A19 and ID=A05, which were previously selected in the process of the second item with the higher priority “1”, are deleted (hatched parts 802a and 802b of 802). The second condition is described as <period>, <start>2 days ago</start>, <end>now</end>, </period> (see lines 13-16 in FIG. 3). Specifically, “in the description of the article posting period condition, only the period from two days ago (2 days ago) to the present (now) is allowed.” Since there is no article which fails to meet this condition in the search result list 801 of FIG. 8, none of the articles is deleted. If the check of the article delete condition 221 described in the script 200 is completed, the process goes to step S204.

Next, the information selector 103 reads in the articles of the search result list 802 one by one (step S205) until the number of articles stored in the work information storage 104 meets the output article number 213 or until there remains no article that is to be read in from the search result list 802 (step S204). The process of steps 5204 to 5207 is repeatedly executed until there remains no article, and the process is finished if there remains no article.

The information selector 103 checks the degree-of-attention threshold 222 with respect to the read-in article if the article is present (step S206). If the degree of attention of the article exceeds the degree-of-attention threshold 222, this article is stored in the work information storage 104 (step S207). In the process of step S206, if the degree of attention of the article does not exceed the degree-of-attention threshold 222, the process returns to step S204.

In the search result list 802 of FIG. 8, if the process is executed from the left-side article, ID=A16, ID=B39, ID=B24, ID=A17 and ID=B46 meet the degree-of-attention threshold, i.e. “the number of bookmarks (BOOKMARKS) is 30 or more”, and thus these are selected and stored in the work information storage 104. The number of selected articles at this time point meets the output article condition 213 (“5” in this example).

Accordingly, the process of the first item with the priority “2” is completed. In the meantime, the number of bookmarks (BOOKMARKS) is less than 30 in ID=A11 and ID=A09, and these fail to meet the select condition.

As a result of the above process, articles 803a to 803e in white (not hatching) are selected as to-be-output articles, among the articles described in the search result list 803, and are stored in the work information storage 104.

By the above-described process, the information selector 103 can select to-be-output articles from the articles described in the search result list 803. Then, the information selector 103 outputs the selected articles to the display module or the like.

According to the information select apparatus 100 of the present embodiment, the information selector 103 selects, according to the script, articles which are collected from the information aggregation site 300 on the Web. Thereby, the information according to the user's preference or condition of use can be provided to the user, without causing trouble to the user.

### Second Embodiment

In a second embodiment, a description is given of an information select apparatus which provides a user with a contents group, which is acquired from an information aggregation site, in an order proper to each content, for example, based on the user's condition of use or a creator's intention.

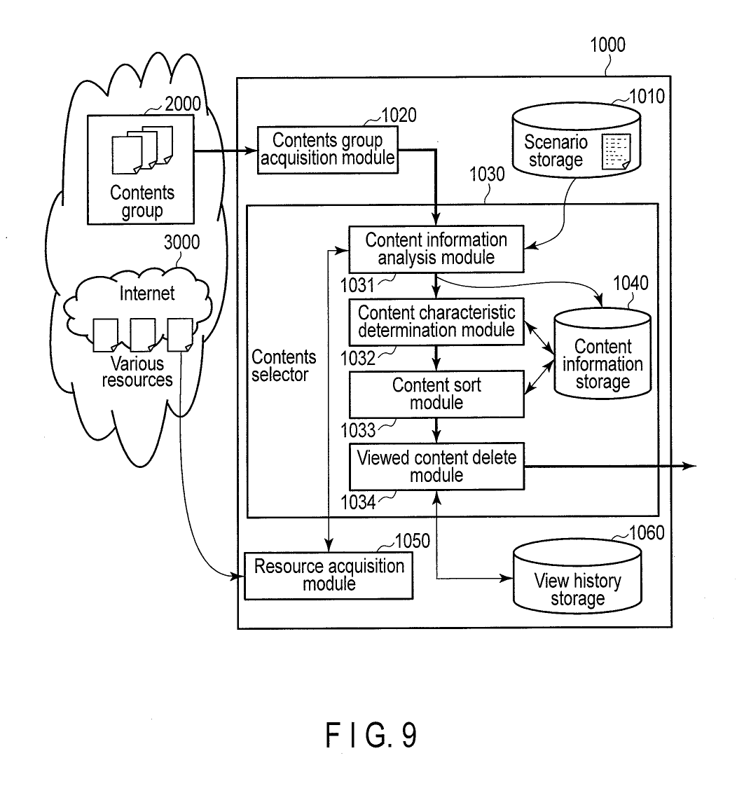

FIG. 9 is a block diagram showing the structure of the information select apparatus according to the present embodiment. An information select apparatus 1000 comprises a scenario storage 1010, a contents group acquisition module 1020, a content selector 1030, a content information storage 1040, a resource acquisition module 1050, and a view history storage 1060. In addition, the content selector 1030 includes a content information analysis module 1031, a content characteristic determination module 1032, a content sort module 1033, and a viewed content delete module 1034. The scenario storage 1010, content information storage 1040 and view history storage 1060 may not be independent memories as shown in FIG. 9, but areas for storing them may be set in the same memory.

The information select apparatus 1000 executes rearrangement which is proper to the characteristic of each content of the acquired contents group 2000, and presents the contents to the user. In the present embodiment, each content comprises a scenario in which the structure of the content is described, and a resource on the Internet 3000 which is designated by the scenario. In the scenario, content information (to be described later) or the destination of acquisition of the resource on the Internet 3000 is described with respect to each content.

The scenario storage 1010 stores the scenario of each content. The scenario storage 1010 is connected to the content information analysis module 1031 of the content selector 1030.

The contents group acquisition module 1020 is connected to the Internet 3000 and the content information analysis module 1031. The contents group acquisition module 1020 acquires the contents group 2000 from the Internet 3000. Then, the contents group acquisition module 1020 delivers the acquired contents group 2000 to the content information analysis module 1031 of the content selector 1030.

The content information storage 1040 stores, with respect to each of the contents, information relating to content (to be described later) and information relating to the resource of the content.

The resource acquisition module 1050 stores acquisition destination information of the resource on the Internet 3000, which is used by the content.

The view history storage 1060 stores a past content view history of the user.

The content information analysis module 1031 of the content selector 1030 is connected to the contents group acquisition module 1020, scenario storage 1010, content information storage 1040, content characteristic determination module 1032, and resource acquisition module 1050. The content information analysis module 1031 obtains information of each content, based on the scenario of the scenario storage 1010. In addition, the content information analysis module 1031 obtains the acquisition destination information of the resource of each content of the contents group 2000 from the Internet 3000 via the resource acquisition module 1050. With respect to each content, this information is stored in the content information storage 1040.

The content characteristic determination module 1032 is connected to the content information analysis module 1031, content information storage 1040 and content sort module 1033. The content characteristic determination module 1032 determines whether a set of contents having a preset characteristic is present in the contents group 2000.

The content sort module 1033 is connected to the content characteristic determination module 1032, content information storage 1040 and viewed content delete module 1034. The content sort module 1033 executes rearrangement of contents with respect to each contents set having a certain characteristic.

The viewed content delete module 1034 is connected to the content sort module 1033 and view history storage 1060. Based on the past view history of the user, which is stored in the view history storage 1060, the viewed content delete module 1034 confirms whether there is an already viewed content in the contents rearranged based on a certain characteristic. If there is an already viewed content, the already viewed content is deleted from the contents, and the contents are output.

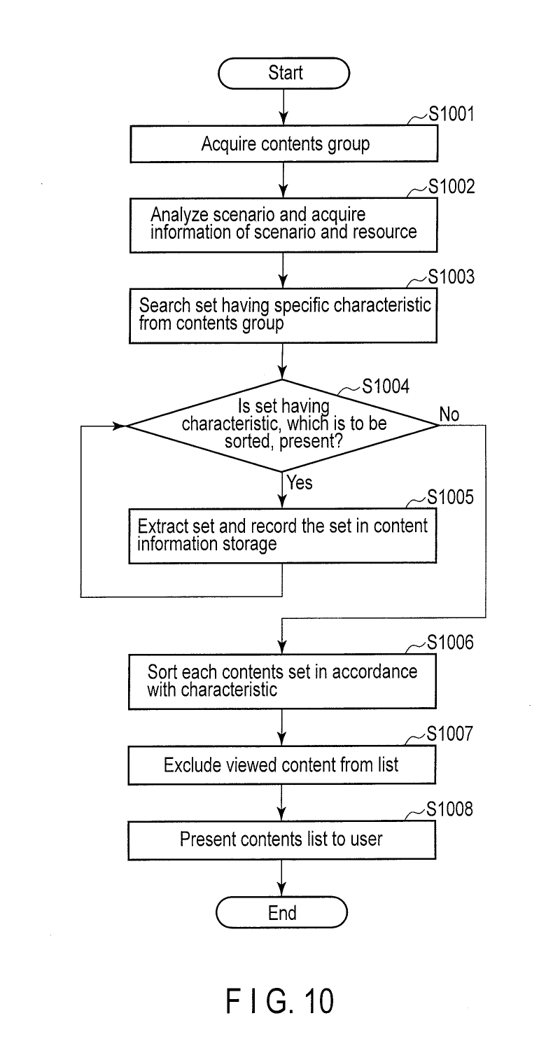

Next, the operation of the information select apparatus according to the present embodiment is described. FIG. 10 is a flow chart illustrating the operation of the information select apparatus according to the present embodiment.

To start with, the contents group acquisition module 1020 acquires the contents group 2000 via the Internet 3000 (step S1001). The contents group 2000 that is acquired is a list of contents. The contents group acquisition module 1020 delivers the acquired contents group 2000 to the content information analysis module 1031.

Upon receiving the contents group 2000 from the contents group acquisition module 1020, the content information analysis module 1031 acquires the scenario corresponding to each content from the scenario storage 1010. The content information analysis module 1031 acquires information of content, based on the analyzed scenario (S1002). As the information of the content described in the scenario, the following may be used:

1) Title of content,

2) Creator of content,

3) Keyword of content,

4) Genre of content,

5) Description of content,

6) Registration time of content, and

7) Acquisition destination information of the resource on the Internet, which is used by content.

In addition, the content information analysis module 1031 acquires the resource, which is used by the content, from the Internet 3000 via the resource acquisition module 1050. The content information analysis module 1031 analyzes the acquired resource and acquires information of the resource (step S1002). Examples of the information of the resource are as follows:

1) Information of the number of bookmarks or the number of comments, which is given to the resource in, for example, an external social bookmark site, and

2) Information of connection/reference relations by links between resources or track-backs.

The content information analysis module 1031 acquires the information of the scenario and the information of the resource with respect to each content from the contents group 2000 on the Web, and then stores the information in the content information storage 1040 with respect to each content. The content information analysis module 1031 delivers the contents group 2000 to the content characteristic determination module 1032.

The content characteristic determination module 1032 determines whether a set of contents having a preset characteristic is present in the received contents group 2000, by acquiring the content information from the content information storage 1040 (step S1003). If a contents set having a certain characteristic is found (“YES” in step S1004), the information of correspondency between the characteristic and the contents in the contents set are stored in the content information storage 1040 (step S1005).

When there are a plurality of characteristics that are to be determined, the content characteristic determination module 1032 searches the contents group for contents sets having the respective characteristics. When such contents sets have been found, the information of the correspondency between the characteristic and the respective contents is stored in the content information storage 1040. If the content characteristic determination module 1032 has determined the sets of contents with respect to all the plurality of characteristics (“NO” in step S1004), the content characteristic determination module 1032 delivers the contents group 2000 to the content sort module 1033.

As the method of extracting contents sets of respective characteristics in the content characteristic determination module 1032, the following methods may be used:

1. Contents with respect to which the order of playback is designated in the scenario.

The target contents, with respect to which the designation of the order of playback is included in the description of the contents of the scenario, are searched from the contents group, and the set of contents, which are coupled by the designation of the order of playback, is extracted.

2. Contents with respect to which it is described in the scenario that the contents are contents of a special series.

Contents, which are designated as the same series by, for example, the contents description of the scenario or keyword, are searched from the contents group, and the set of the contents is extracted.

3. Contents which use resources having relations of reference to resources of other contents.

Contents, which use resource having relations of reference to resources of a certain content by links or track-backs, are searched from the contents group, and a set of contents having a relation of reference is extracted.

4. Contents using the same resource.

Contents using the same resource are searched from the contents group and a set of contents is extracted.

5. Contents of the same content genre described in the scenario.

Contents of the same genre described in the scenario are searched from the contents group, and a set of the contents are extracted.

The content characteristic determination module 1032 may use other characteristics, aside from the above-described characteristics.

If the content sort module 1033 receives the contents group 2000 from the content characteristic determination module 1032, the content sort module 1033 acquires the information of correspondency between the characteristic and the content from the content information storage 1040. The content sort module 1033 rearranges the contents in the contents set with respect to each characteristic (step S1006). When contents having a plurality of characteristics are present in the contents group 2000, the priority relating to the characteristics is set. It may be determined with respect to which characteristic the sorting is to first executed. When the content sort module 1033 has completed the sorting with respect to all characteristics, the content sort module 1033 delivers the sorted contents group 2000 to the viewed content delete module 1034.

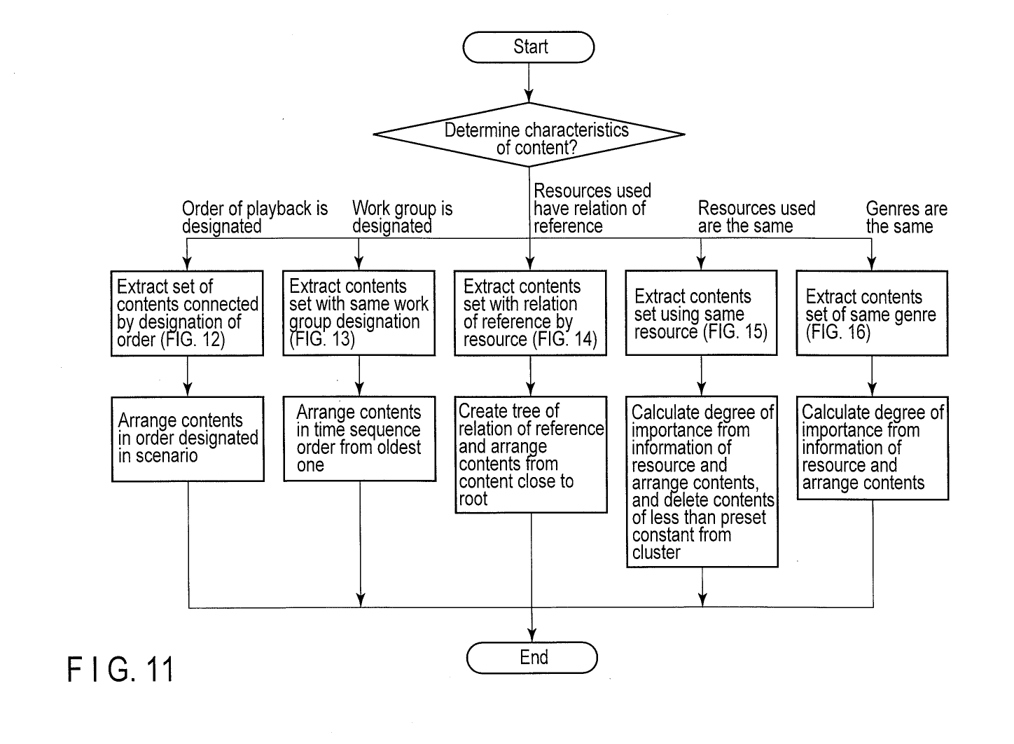

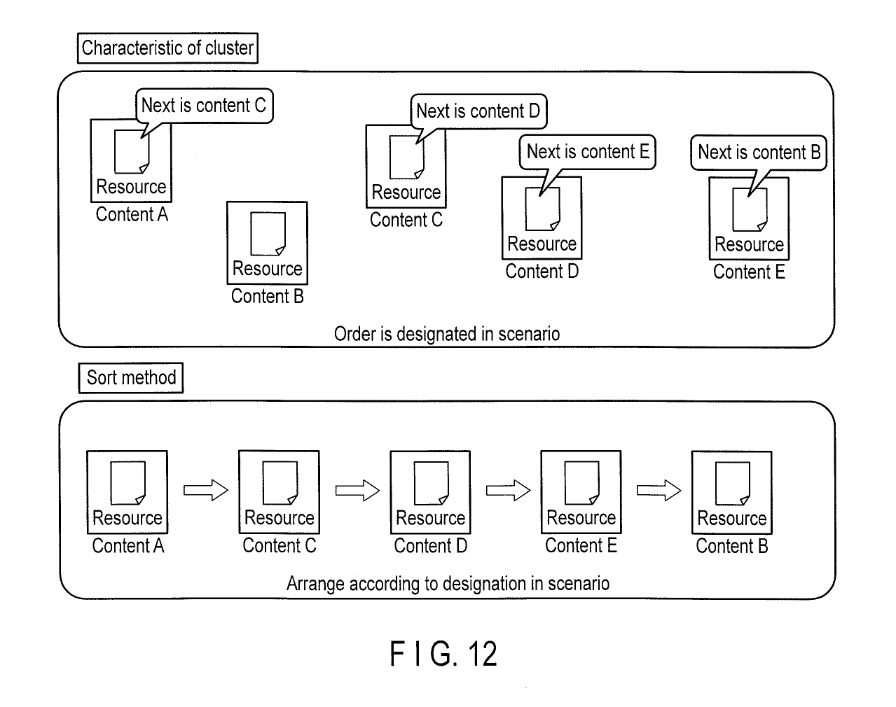

In the content sort module 1033, any one of the methods described below is used as the method of sorting the contents in the contents set with respect to each characteristic. FIG. 11 is a flow chart of a sort operation of contents. FIG. 12 to FIG. 16 illustrate the characteristics of contents and the method of sorting contents with respect to the characteristics.

1. Contents set with respect to which the order of playback is designated in the scenario (FIG. 12)

Contents are arranged in the order designated in the scenario. In the example of FIG. 12, the order is: content A, content C, content D, content E, and content B.

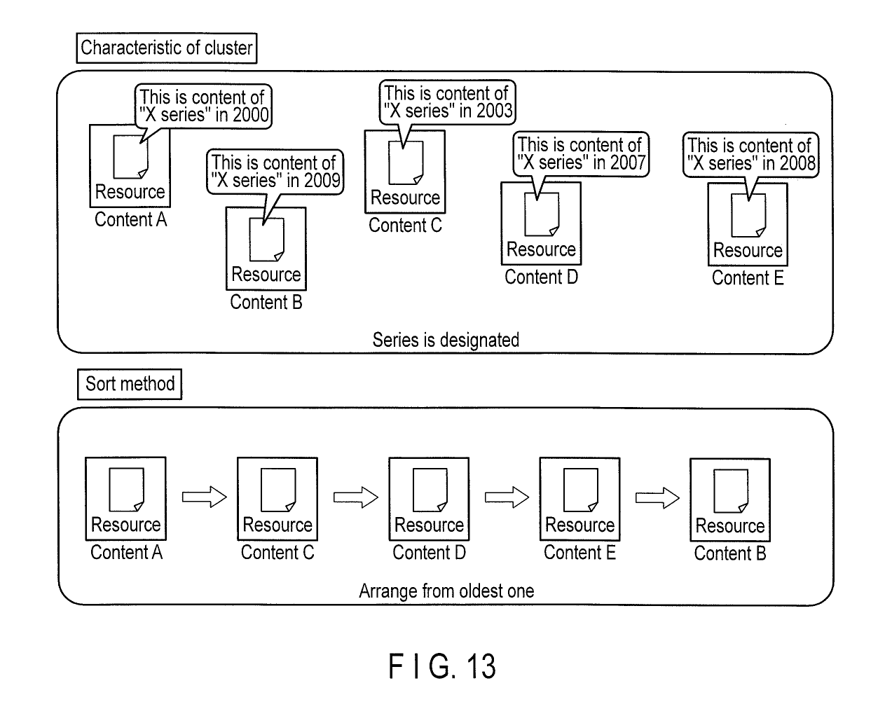

2. Contents set with respect to which it is designated in the scenario that the contents set is of the same series (FIG. 13)

If the order is not designated in the scenario, contents are arranged in the time sequence order from the oldest one. In the example of FIG. 13, the order is: content A, content C, content D, content E, and content B.

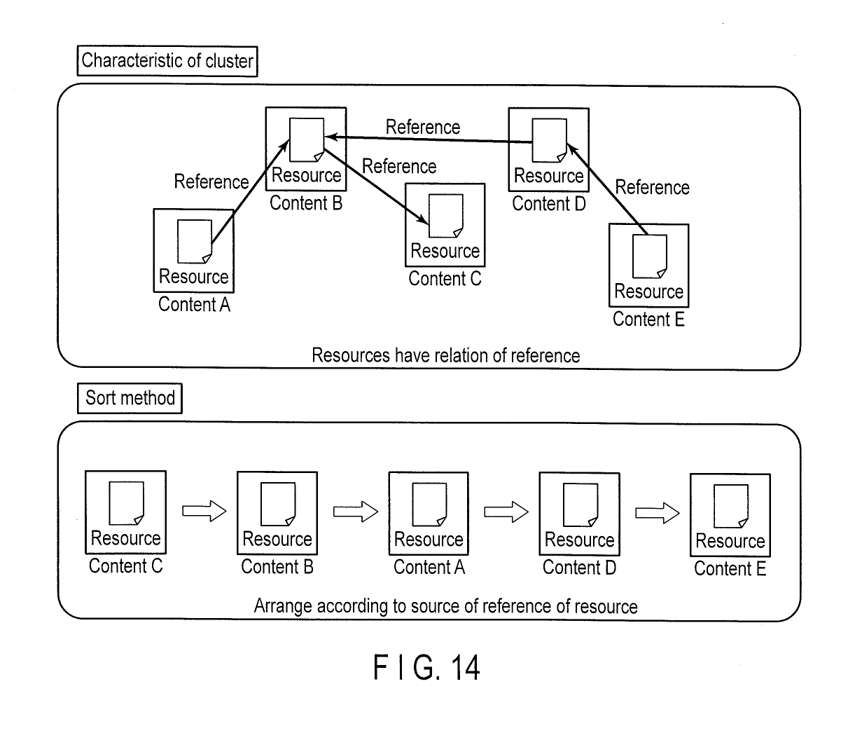

3. Contents set with resources having relations of reference to another content (FIG. 14)

A tree of the relation of reference of resources is created, and contents are arranged according to the hierarchy in the order beginning with the content using the resource that is closest to the root. In the example of FIG. 14, the order is: content C, content B, content A, content D, and content E.

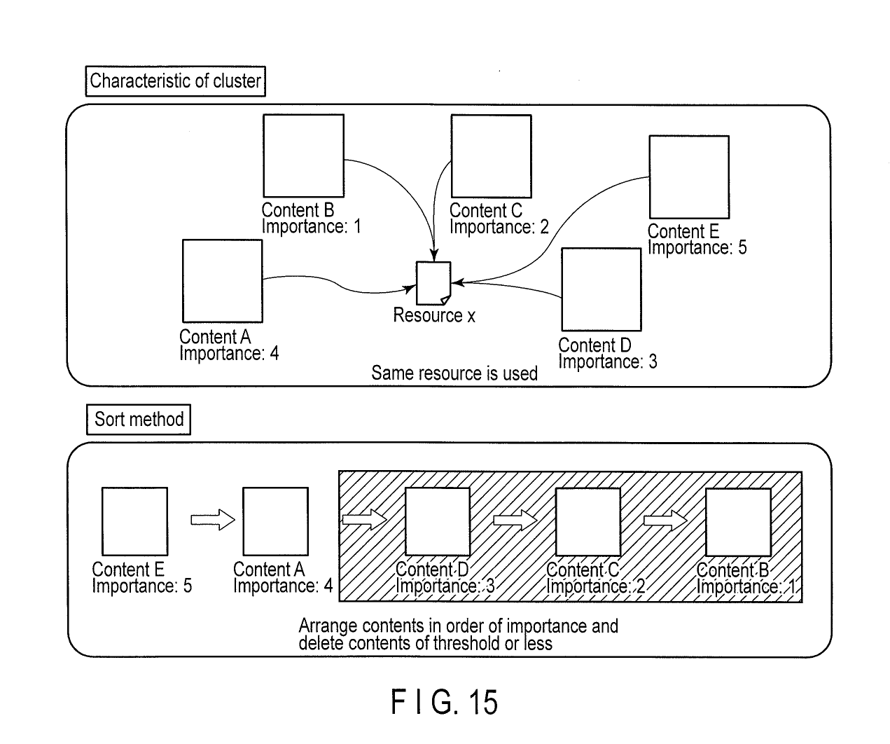

4. Contents set in the case where contents use the same resource (FIG. 15)

The degree of importance, which is described later, is calculated with respect to each content, and the contents are arranged in the order of the degree of importance. In addition, a content having the degree of importance that is lower than a preset threshold is deleted. In the example of FIG. 15, the order is: content E and content A (contents D, C and B are deleted).

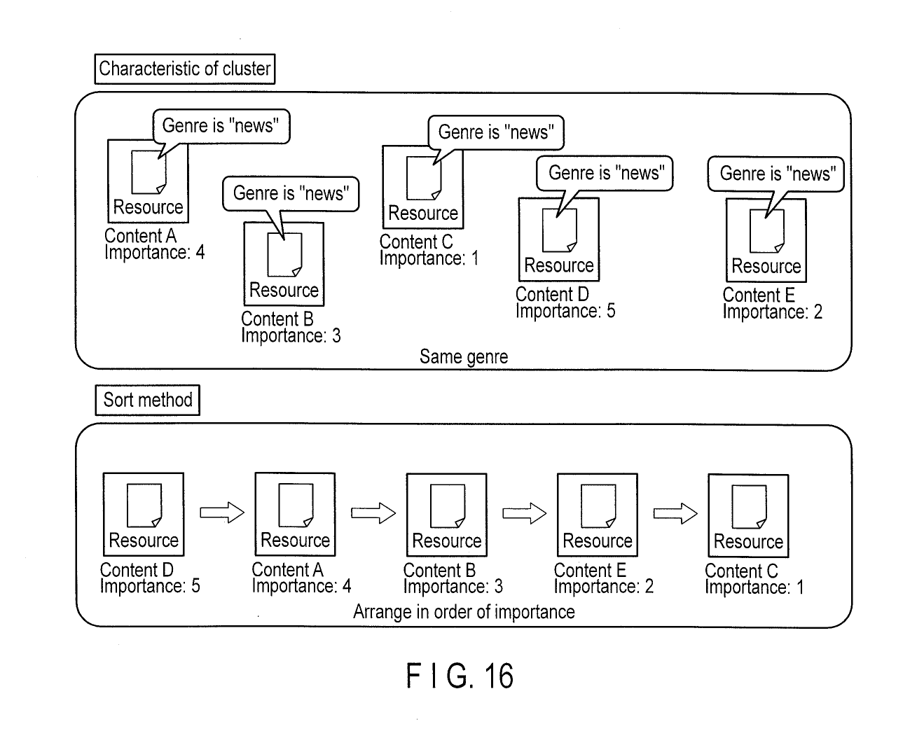

5. Contents set in the case where it is designated in the scenario that contents are of the same series (FIG. 16)

The degree of importance, which is described later, is calculated with respect to each content, and the contents are arranged in the order of the degree of importance. In the example of FIG. 16, the order is: content D, content A, content B, content E, and content C.

Next, an example of the method of calculating the degree of importance is explained. In this method of calculation, the “level of the degree of freshness” or “level of the degree of attention” of each resource is determined.

1. A query about the information of the resource used by a content is issued to the content information storage 1040.

2. Of the information of the resource, the number of track-backs, the number of references in the social bookmark, and the time stamp are acquired.

3. A point is calculated with respect to the acquired information, based on the following standards:

(a) The number (n) of track-backs is added to the point (+n).

(b) The fraction after the decimal point of (the number of references in the social bookmark/100) is rounded down, and the resultant is added.

(c) If the time stamp of the resource is within one day, +5 is added. If the time stamp is within one week, +3 is added. If the time stamp is within one month, +1 is added.

4. The total point calculated in above “3” is set to be the point of the resource.

5. The above is applied to all resources used by the content, and the highest one of the points is set to be the degree of importance of the content.

The sort method and the method of calculating the degree of importance are not limited to the above, and sorting algorithms by other methods may be used.

If the sorted contents group 2000 is delivered from the content sort module 1033, the viewed content delete module 1034 acquires the past view history of the user from the view history storage 1060. Then, the viewed content delete module 1034 confirms whether contents in the contents group 2000 are present in the past view history. If there are viewed content, the viewed content delete module 1034 deletes the corresponding viewed content from the content group 2000 (step S1007).

After completing the deletion of all viewed content, the viewed content delete module 1034 presents the contents group 2000 to the user as the sorted content list (step S1008).

According to the information select apparatus 1000 of the present embodiment, the content selector 1030 selects contents, which have been collected from the Internet 3000, according to the scenario. Thereby, the contents according to the condition of use by the user can be provided to the user, without causing trouble to the user.

In addition, based on the scenario, the content selector 1030 extracts the set of relevant contents, and rearranges the contents with respect to each extracted contents set. Thereby, the contents can be presented to the user in the order according to the characteristics of contents.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information selection apparatus comprising:
storage configured to store a script describing at least
first information indicating a search condition of articles,
second information indicating a select condition of articles, and
third information indicating an output order of articles,
in order to select data which is to be provided to a user;
an acquisition module configured to acquire a data group from a network based on the first information of the script; and
a selector configured to select data items from the data group based on the second information of the script, and to arrange the selected data items based on the third information.

2. The apparatus of claim 1, wherein
the second information comprises a delete condition of data, and
the selector is configured to delete from the selected data items data satisfying the delete condition, and to arrange the data group from which the data has been deleted based on the third information.

3. The apparatus of claim 2, wherein
the second information comprises at least a degree-of-attention threshold, and
the selector is configured to repeat, for a first number of times, a process of deleting from the data group data satisfying the delete condition and a process of selecting from the selected data items from which the data has been deleted data satisfying the degree-of-attention threshold.

4. The apparatus of claim 3, wherein
the second information comprises a characteristic of data,
the selector comprises a characteristic determinator and a sorter,
the characteristic determinator is configured to select data items having a specific characteristic from the data group based on the characteristic of the data, and
the sorter is configured to rearrange the selected data items with respect to each characteristic of the data.

5. The apparatus of claim 4, wherein
the second information comprises a use history of data,
the selector comprises a delete module, and
the delete module is configured to delete from the selected data items which have been rearranged by the sorter data which is described in the use history.

6. An information selection method comprising:
storing a script describing at least
first information indicative of a search condition of articles,
second information indicative of a select condition of articles, and
third information indicative of an output order of articles,
in order to select data which is to be provided to a user;
acquiring a data group from a network based on the first information of the script; and
selecting data items from the data group based on the second information of the script, and
arranging the selected data items based on the third information.

7. The method of claim 6, wherein
the second information comprises a delete condition of data, and
selecting comprises deleting from the selected data items data satisfying the delete condition, and arranging the data group from which the data has been deleted, based on the third information.

8. The method of claim 7, wherein
the second information comprises at least a degree-of-attention threshold, and
the selecting comprises repeating, for a first number of times, a process of deleting from the data group data meeting the delete condition and a process of selecting from the selected data items from which the data has been deleted data meeting the degree-of-attention threshold.

9. The method of claim 8, wherein
the second information comprises a characteristic of data,
selecting comprises selecting data items having a specific characteristic from the data group based on the characteristic of the data, and
rearranging the selected data items with respect to each characteristic of the data.

10. The method of claim 9, wherein
the second information comprises a use history of data,
selecting comprises deleting from the selected data items which have been rearranged data which is described in the use history.
